(19) United States
(12) Patent Application Publication
(10) Pub. No.: US 2008/0106528 A1
(43) Pub. Date: May 8, 2008

(54) Surface acoustic wave touch panel with interdigital transducers

(75) Inventors: Chin-Fu Chang, Tainan County (TW); Shang Tai Yeh, Zhonghe City (TW)

Correspondence Address: RADER FISHMAN & GRAUER PLLC, LION BUILDING, 1233 20TH STREET N.W., SUITE 501, WASHINGTON, DC, 20036, US

(73) Assignee: EGALAX_EMPIA TECHNOLOGY INC., Taipei City (TW)

(21) Appl. No.: 11/806,727

(22) Filed: Jun. 4, 2007

(30) Foreign Application Priority Data
Jul. 10, 2006 (TW) 095125059

(51) Int. Cl. G06F 3/043

(52) U.S. Cl. 345/177

(57) ABSTRACT

A surface acoustic wave (SAW) touch panel with interdigital transducers (IDTs) includes a panel having a first edge, a second edge, a third edge and a fourth edge, a X-axis transmitting transducer, a X-axis receiving transducer, a Y-axis transmitting transducer, a Y-axis receiving transducer and a plurality of reflector structures for reflecting the surface acoustic waves generated by the X-axis transmitting transducer and the Y-axis transmitting transducer. The X-axis transmitting/receiving transducers or the Y-axis transmitting/receiving transducers includes at least one IDT.

### CROSS REFERENCE TO RELATED APPLICATIONS

This application claims the right of priority based on Taiwan Patent Application No. 095125059 entitled “Surface Acoustic Wave Touch Panel with Interdigital Transducers”, filed on Jul. 10, 2006, which is incorporated herein by reference and assigned to the assignee herein.

### FIELD OF INVENTION

The invention is related to a touch panel, especially to a touch panel employing interdigital transducers (IDTs) to generate Surface Acoustic Wave (SAW).

### BACKGROUND OF THE INVENTION

Typically, an input interface for an electronic device does not directly receive voice or handwriting of the user; the user rather relies on a keyboard or a mouse to communicate with the computer. These input devices are not easy to use for everyone, particularly for those who are new to modern electronic devices. Therefore, while the IT products are mushrooming, non-keyboard or non-mouse input means is bond to replace those previous input devices. Among the non-keyboard, non-mouse input means, a touch panel is the most popular technology at present.

Touch panels were developed for U.S. military in 1970's. Then this technology was applied for commercial use since 1980's and resulted in a variety of applications. At present, touch panel is the simplest interface among all the human-machine interfaces. They are provided for pointing and writing directly with fingers or a stylus. Then the locations of the touching points on the touch panel are calculated by an internal mechanism. The results are sent to the IT devices to complete the whole input. Touch panels facilitate the communication between a user and a computer, whereby the user does not need to learn how to use a keyboard or a mouse. Accordingly, touch panels are generally adopted in, for example, eBooks, GPS, PDA, web phones, mini notebooks, Web Pads, Hand-held PCs, etc.

Generally, a touch panel is composed of a conductive glass and a conductive film. Then touch panels can be classified into four types—Resistive, Capacitive, Infrared, and Surface Acoustic Wave (SAW). A surface acoustic wave (SAW) is a type of mechanical wave motion which travels along the surface of a solid material. Accordingly, SAW-type of the touch pad relies on that when SAW is propagated on a surface and is hampered by an object on this surface, the location of that object can be determined by detecting the distorted SAW.

A typical transducer, such as a wedge-shaped transducer shown in FIG. 1, employs shear waves to generate SAW. Or a comb-shaped transducer, shown in FIG. 2, generates SAW by longitudinal waves. Through the piezoelectric material 130 or 230 shown in FIG. 1 or FIG. 2, the transducer mentioned above utilizes the “piezoelectric effect” to convert mechanical energy into electric energy. Another basic SAW device consists of two interdigital transducers (IDTs) on a piezoelectric substrate such as quartz. The IDTs consist of interleaved metal electrodes which are used to launch and receive the waves, so that an electrical signal is converted to an acoustic wave and then back to an electrical signal.

In a conventional touch panel having transducers, the transducers are disposed in pairs and arranged along the entire edges of the panel. However, this arrangement results in high cost. Therefore, it is necessary to have a more economical way to incorporate transducers into a touch panel.

### SUMMARY OF THE INVENTION

One aspect of the invention provides a touch panel, including a panel, an X-axis transmitting transducer, an X-axis receiving transducer, a Y-axis transmitting transducer, a Y-axis receiving transducer, and a plurality of reflector structures. A surface of the panel has a first edge, a second edge, a third edge, and a fourth edge. The X-axis transmitting transducer is disposed at one end of the first edge, and the X-axis receiving transducer is disposed at the other end of the first edge. The Y-axis transmitting transducer is disposed at one end of the second edge, and the Y-axis receiving transducer is disposed at the other end of the second edge. The reflector structures are placed along the first edge, the second edge, the third edge, and the fourth edge, and are provided for reflecting SAW generated by the X-axis transmitting transducer and the Y-axis transmitting transducer. Then the X-axis receiving transducer and the Y-axis receiving transducer receive the reflected SAW. At least one of the X-axis transmitting transducer, the X-axis receiving transducer, and the Y-axis transmitting/receiving transducer includes at least one interdigital transducer.

### BRIEF DESCRIPTION OF THE DRAWINGS

FIG. 1 illustrates a wedge-shaped transducer;

FIG. 2 illustrates a comb-shaped transducer;

FIG. 3 shows a touch panel employing interdigital transducer according to an embodiment of the present invention;

FIG. 4 shows the voltage of the receiving transducer when nothing touches the panel;

FIG. 5 shows the voltage of the receiving transducer when the panel is touched by an object; and

FIG. 6 illustrates an interdigital transducer according to an embodiment of the present invention.

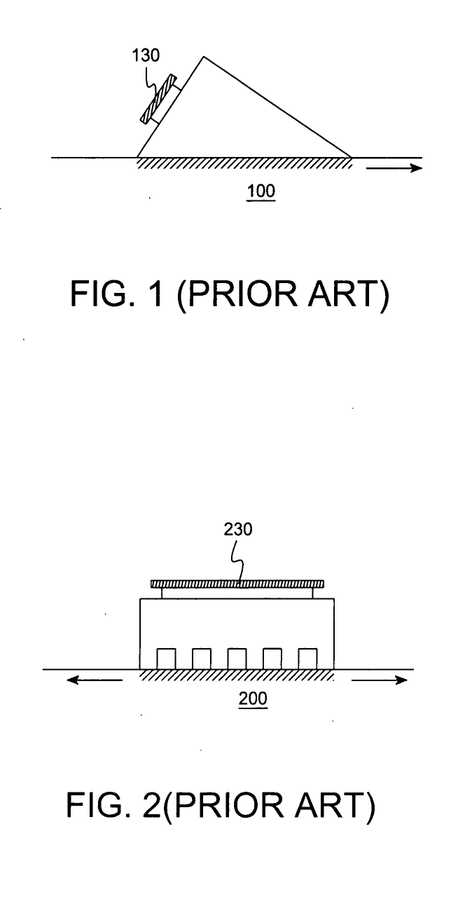

### DETAILED DESCRIPTION

The present invention discloses a touch panel with enhanced accuracy. The foregoing and other features of the invention will be apparent from the following more particular description and figures of embodiment of the invention.

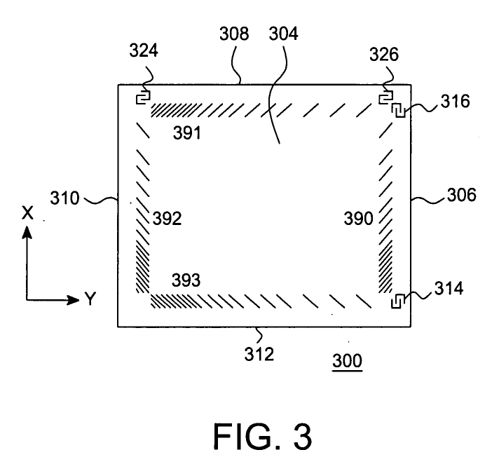

FIG. 3 shows a touch panel employing interdigital transducers according to an embodiment of the invention. The touch panel 300 includes a panel 304, an X-axis transmitting transducer 314, an X-axis receiving transducer 316, a Y-axis transmitting transducer 324, a Y-axis receiving transducer 326, and a plurality of reflector structures 390, 391, 392 and 393. The panel 304 can be made of acrylic, glass, plastic or other materials. The surface of the panel 304 has a first edge 306, a second edge 308, a third edge 310, and a fourth edge 312. The X-axis transmitting transducer 314 is disposed at one end of the first edge 306, and the X-axis receiving transducer 316 is disposed at the other end of the first edge 306. The Y-axis transmitting transducer 324 is disposed at one end of the second edge 308 and is diagonal to the X-axis receiving transducer 316. The Y-axis receiving transducer 326 is disposed at the other end of second edge 308. The reflector structures 390, 391, 392 and 393 are placed respectively along the first edge 306, the second edge 308, the third edge 310, and the fourth edge 312. In FIG. 3, the X-axis transmitting transducer 314, the X-axis receiving transducer 316, the Y-axis transmitting transducer 324, and the Y-axis receiving transducer 326 are embodied as interdigital transducers. However, in other embodiments, transducers 314, 316, 324 and 326 may be selected from a group consisting of other types of transducers and interdigital transducers.

As shown in FIG. 3, reflector structures 390, 391, 392 and 393 are embodied as reflecting patterns. The reflecting patterns get denser as they are farther from the X-axis transmitting transducer 314, the X-axis receiving transducer 316, the Y-axis transmitting transducer 324, and the Y-axis receiving transducer 326. The reflecting patterns are disposed 45 degrees to any one of the first edge 306, the second edge 308, the third edge 310, and the fourth edge 312.

In one embodiment, the SAW generated by the X-axis transmitting transducer 314 is first reflected by the reflecting patterns 393 and is propagated along the direction of +X. Then the SAW is reflected by the reflecting patterns 391 and is turned towards the direction of +Y. At last, the SAW is received by the X-axis receiving transducer 316 and is converted into electric energy. Similarly, the SAW generated by the Y-axis transmitting transducer 324 is first reflected by the reflecting patterns 392 and is propagated along the direction of +Y. Then the SAW is reflected by reflecting patterns 390 and is turned towards the direction of +X. At last, the SAW is received by the Y-axis receiving transducer 326 and is converted into electric energy. It should be noted that the reflecting patterns are arranged 45 degrees to the edges in this embodiment, but the arrangements of other degrees are also covered by the present invention.

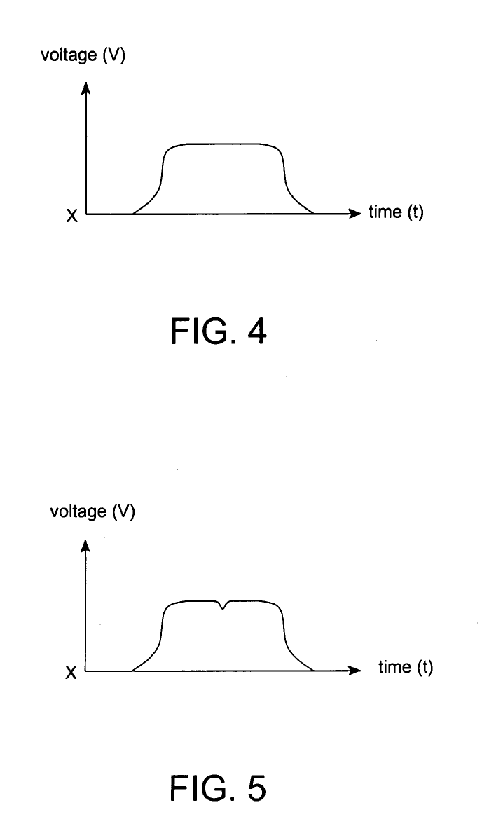

FIG. 4 and FIG. 5 further explain the operation of the X-axis receiving transducer 316 according to an embodiment. FIG. 4 shows the voltage of the X-axis receiving transducer 316 when nothing touches the panel 304. FIG. 5 shows the voltage of the X-axis receiving transducer 316 when an object touches the panel 304. In FIG. 5, shown as a dip of the voltage, the energy of SAW is partly absorbed by the touching object. The SAW reflected by reflecting patterns 391 or 393 have different propagating distances, by which the position of the touching point in the X-axis can be determined. By the similar manner, the position in the Y-axis can be determined.

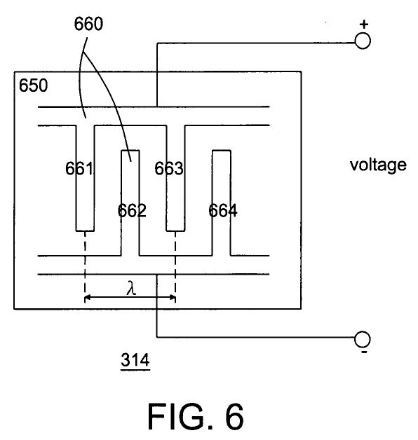

FIG. 6 shows an embodiment with an interdigital transducer. The X-axis transmitting transducer 314 is formed by coating a piezoelectric film 650 and then coating an interdigital electrode 660 on the piezoelectric film 650. The interdigital electrode 660 includes a plurality of toe-shaped protrusions, such as the toe 661 and the toe 663 of anode as well as the toe 662 and the toe 664 of cathode, arranged in an interleaved way. These toe-shaped protrusions are arranged in an interlaced way. If a voltage is applied to the interdigital transducer 314, two adjacent electrodes 660 (e.g., anode 661 and cathode 662) will give rise to an electric field, and the piezoelectric material will be deformed due to the electric field. If an alternating voltage is applied to the interdigital transducer 314, accordingly the piezoelectric material will constantly generate a sequence of SAW.

With such a specific arrangement of the electrodes, the generated SAW will cause the constructive interference. As shown, the SAW from the toe 661 is propagated to the toe 663 via the toe 662. If the SAW from the toe 663 and the SAW from the toe 661 have a timing difference of a period T (T=1/f, f is the frequency of SAW), or if the toe 663 and the toe 661 are separated by a wavelength λ (λ is the wavelength of the acoustic wave), the SAW from the toe 663 and the SAW from the toe 661 will have constructive interference. That is, two adjacent anodes (or two adjacent cathodes) are separated by a λ; and one anode and the adjacent cathode are separated by a λ/2. Those skilled in the art should understand that the X-axis receiving transducer 316, the Y-axis transmitting transducer 324, or the Y-axis receiving transducer 326 can have the interdigital electrodes like the ones of the X transmitting transducer 314.

Furthermore, in one embodiment, the sol-gel method is adopted to form the piezoelectric film 650. First, piezoelectric materials are dissolved in solvents, such as water or alcohol, to perform hydrolysis or condensation reactions and then to form the gel. And the panel is further coated with the gel. The characteristics of the film are strongly related to the processing conditions of the gel. The processing conditions generally relate to the piezoelectric materials, the concentration, solvents, temperature, the pressures, and pH values.

In another embodiment, chemical vapor deposition (CVD) is adopted to form the piezoelectric film 650. First the piezoelectric material is formed as solid product, and then deposited onto the panel. In yet another embodiment, diffused reactants are disposed next to the panel and then are attached to the surface of the panels to form the solid products. The residues are exhausted with other gaseous by-products. Those skilled in the art should know other methods to produce the piezoelectric film 650, such as metal-organic decomposition, screen print, nebulization spray, etc. Meanwhile, the piezoelectric materials can be ZnO, AlN, PZT, PbTiO₃, LiNbO₃, etc. After the piezoelectric film 650 is formed, the interdigital electrode 660 is further formed on the piezoelectric film 650 by the metal deposition, evaporation, sputtering, or any other manners known to those skilled in the art. The interdigital electrodes 660 can be made of Ag, Al, Au, or other appropriate materials.

As understood by those skilled in the art, interdigital transducers employed in a touch panel can save previous processes of attaching the wedge-shaped transducers or the comb-shaped transducers to the panel. The process of coating the piezoelectric film onto the panel and the metal electrodes on the piezoelectric film is simpler than the conventional process. In addition, the arrangement of the reflection structures can eliminate the need of disposing transducers around the panel and thus reduce the cost.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A touch panel, comprising:
a panel, a surface of said panel having a first edge, a second edge, a third edge, and a fourth edge;
an X-axis transmitting transducer at one end of said first edge;
an X-axis receiving transducer at the other end of said first edge;
a Y-axis transmitting transducer at one end of said second edge;
a Y-axis receiving transducer at the other end of said second edge; and
a plurality of reflector structures placed along said first edge, said second edge, said third edge, and said fourth edge, and said plurality of reflector structures being provided for reflecting surface acoustic waves (SAW) generated by said X-axis transmitting transducer and said Y-axis transmitting transducer, said X-axis receiving transducer and said Y-axis receiving transducer then receiving said reflected SAW;
wherein at least one of said X-axis transmitting transducer, said X-axis receiving transducer, said Y-axis transmitting transducer, and said Y-axis receiving transducer comprises at least one interdigital transducer.

2. The touch panel of claim 1, wherein said at least one interdigital transducer comprises a piezoelectric film and interdigital electrodes on said piezoelectric film.

3. The touch panel of claim 2, wherein said piezoelectric film is a film of ZnO, AlN, PZT, PbTiO₃, or LiNbO₃.

4. The touch panel of claim 2, wherein said interdigital electrodes comprise a plurality of toe-shaped protrusions, and said toe-shaped protrusions are arranged in an interlaced way.

5. The touch panel of one of claim 2, wherein said interdigital electrodes are made of Ag, Al or Au.

6. The touch panel of one of claim 2, wherein the said interdigital electrodes comprise interleaved anodes and cathodes, and each anode and the adjacent cathode are separated by a distance of λ/2.

7. The touch panel of claim 1, wherein said panel is made of acrylic, glass, or plastic.

8. The touch panel of claim 1, wherein said X-axis transmitting transducer and said Y-axis transmitting transducer are placed in diagonal corners of said panel.

9. The touch panel of claim 1, wherein said reflector structures are reflecting patterns, and said reflecting patterns are arranged denser as farther from said X-axis transmitting transducer, said X-axis receiving transducer, said Y-axis transmitting transducer, or said Y-axis receiving transducer.

10. The touch panel of claim 9, wherein each of said reflecting patterns is 45 degrees to any one of said first edge, said second edge, said third edge, or said fourth edge, and wherein acoustic waves generated by said X-axis transmitting transducer and said Y-axis transmitting transducer are perpendicularly reflected by said reflecting patterns.
